(19) United States
(12) Patent Application Publication
(10) Pub. No.: US 2024/0364623 A1
(43) Pub. Date: Oct. 31, 2024

(54) METHOD, APPARATUS, DEVICE, STORAGE MEDIUM AND PROGRAM FOR DATA TRANSMISSION

(71) Applicant: BEIJING BYTEDANCE NETWORK TECHNOLOGY CO., LTD., Beijing (CN)

(72) Inventors: Shu SHI, Beijing (CN); Bin XU, Beijing (CN)

(21) Appl. No.: 18/571,610

(22) PCT Filed: Jul. 26, 2022
(86) PCT No.: PCT/CN2022/108052

§ 371 Date: Dec. 18, 2023

(30) Foreign Application Priority Data
Aug. 23, 2021 (CN) 202110967138.9

(51) Int. Cl. H04L 45/24; H04L 45/302

(52) U.S. Cl. CPC H04L 45/245; H04L 45/302

(57) ABSTRACT

Embodiment of the present disclosure provide a method, apparatus, device, electronic device, computer readable storage medium, computer program product and computer program for data transmission. The method comprises: obtaining, by a cloud server, target media data to be sent to a terminal device; determining at least two physical transmission paths from the cloud server to the terminal device; and transmitting the target media data to the terminal device on the at least two physical transmission paths, wherein the media data transmitted on each physical transmission path is part or all of the target media data. As such, multipath transmission is realized, thereby ensuring a lower response delay and improving user experience.

### CROSS REFERENCE

The present application claims priority to Chinese Patent Application No. 202110967138.9, filed on Aug. 23. 2021, entitled “METHOD, APPARATUS, DEVICE, STORAGE MEDIUM AND PROGRAM FOR DATA TRANSMISSION”, the entirety of which is incorporated herein by reference.

### FIELD

Embodiments of the present disclosure relate to the field of cloud technology, and more particularly, to a method for data transmission, apparatus, device, electronic device, storage medium, computer program product and computer program.

### BACKGROUND

With the development of network technology, Streaming Media applications have been widely used. Common Streaming Media applications include but are not limited to: network LIVE applications, film and television applications, Cloud Gaming applications, etc. Taking Cloud Gaming applications as an example, game programs run on cloud servers, users issue game instructions through terminal devices to control the game programs on cloud servers, and cloud servers render game images according to game instructions and send them to terminal devices for display.

Cloud gaming applications have strict response Latency requirements. Response Latency refers to the time from the user issuing a game command through the terminal device to the user seeing the game screen on the terminal device. When the response Latency is large, the user will feel that the game is stuttering. In related technologies, response Latency can be reduced by reducing data buffers, optimizing transmission protocols, and other methods.

However, the inventors have found that the above-mentioned related art has at least the following technical problems: in the case of network congestion between the cloud server and the terminal device, there is still a problem of high response delay.

### SUMMARY

Embodiments of the present disclosure provide a method for data transmission, apparatus, apparatus, electronic device, computer-readable storage medium, computer program product and computer program to solve the problem of high response delay.

In a first aspect, embodiments of the present disclosure provide a method for data transmission, comprising: obtaining target media data to be sent to a terminal device; determining at least two physical transmission paths from the cloud server to the terminal device; and transmitting the target media data to the terminal device on the at least two physical transmission paths, wherein media data transmitted on each of the physical transmission paths is part or all of the target media data.

In a second aspect, embodiments of the present disclosure provide an apparatus for data transmission, wherein the apparatus is applied at a cloud server, and the apparatus comprise: an obtaining module configure to obtain target media data to be sent to a terminal device; a determining module configured to determine at least two physical transmission paths from the cloud server to the terminal device; and a transmission module configured to transmit the target media data to the terminal device on the at least two physical transmission paths, wherein media data transmitted on each of the physical transmission paths is part or all of the target media data.

In a third aspect, embodiments of the present disclosure provide an electronic device, comprising: a processor and a memory. The memory stores computer-executable instructions. The processor executes the computer-executable instructions to implement the method for data transmission as described in the first aspect and various possible designs thereof.

In a fourth aspect, embodiments of the present disclosure provide a computer-readable storage medium. The computer-readable storage medium stores computer-executable instructions that, when executed by a process, implement the method for data transmission as described in the first aspect and various possible designs thereof.

In a fifth aspect, embodiments of the present disclosure provide a computer program product comprising a computer program. The computer program, when executed by a processor, implements the method for data transmission as described in the first aspect and various possible designs thereof.

In a sixth aspect, embodiments of the present disclosure provide a computer program. The computer program, when executed by a processor, implements the method for data transmission as described in the first aspect and various possible designs thereof.

According to the method for data transmission, apparatus, device, electronic device, computer readable storage medium, computer program product and computer program provided in the present disclosure, the cloud server obtains target media data to be sent to the terminal device, determines at least two physical transmission paths leading from the cloud server to the terminal device, and transmits the target media data to the terminal device on the at least two physical transmission paths; wherein the media data transmitted on each physical transmission path is part or all of the target media data. In this way, multipath transmission is realized. When one of the physical transmission paths is congested in the network, the media data transmitted by other physical transmission paths is not affected, and the terminal device can also display the media data received through other physical transmission paths, thereby ensuring a lower response delay and improving user experience.

### BRIEF DESCRIPTION OF THE DRAWINGS

In order to more clearly illustrate the technical solutions in the disclosed embodiments or Prior Art, the following will be a brief introduction to the accompanying drawings required for the description of the embodiment or Prior Art. Obviously, the accompanying drawings in the following description are some embodiments of the present disclosure. For those of ordinary skill in the art, without creative labor, other drawings can be obtained based on these drawings.

FIG. 1 is a schematic diagram of the cloud gaming scenario provided in embodiments of the present disclosure;

FIG. 2 is a schematic diagram of the response delay in the cloud gaming scenario provided in embodiments of the present disclosure;

FIG. 3 is a flowchart of a method for data transmission according to the present embodiment;

FIG. 4 is a schematic diagram of a plurality of physical transmission paths provided in embodiments of the present disclosure;

FIG. 5 is a schematic diagram of a multipath transmission provided in embodiments of the present disclosure;

FIG. 6 is a schematic diagram of another embodiment of embodiments of the present disclosure provide a multipath transmission;

FIG. 7 is a schematic diagram of another embodiment of embodiments of the present disclosure provide a multipath transmission;

FIG. 8 is a schematic diagram of another embodiment of embodiments of the present disclosure provide a multipath transmission;

FIG. 9 is a schematic diagram of the structure of an apparatus for data transmission provided in embodiments of the present disclosure; and

FIG. 10 is a schematic structural diagram of an electronic device according to the present embodiment of the disclosure.

### DETAILED DESCRIPTION

In order to make the purpose, technical solution, and advantages of the disclosed embodiment clearer, the technical solution in the disclosed embodiment will be clearly and completely described below in conjunction with the accompanying drawings in the disclosed embodiment. Obviously, the described embodiment is a part of the disclosed embodiment, not all embodiments. Based on the embodiments in the disclosed embodiment, all other embodiments obtained by those skilled in the art without creative labor are within the scope of protection of the disclosed embodiment.

First, the concepts and terms involved in embodiments of the present disclosure will be explained.

Scaled Video Coding (SVC) is a technology that is compatible with different terminal devices and link bandwidths. Its feature is the layering of bitstreams. Lower-level bitstreams can be decoded separately, while higher-level bitstreams can enhance video quality. Common grading methods include time-domain grading, spatial grading, quality grading, etc. SVC is a technology that can divide video streams into multiple resolution, quality, and frame rate layers. It is an extension of the H.264 video codec standard used by most video conferencing devices today. Video conferencing devices use SVC technology to send and receive multi-layer video streams composed of a small base layer and multiple optional layers that can improve resolution, frame rate, and quality. This layering method can greatly improve error elasticity and video quality, and does not have high bandwidth requirements. In addition, a multi-layer SVC video stream can support multiple devices and networks.

I Frame, also known as Intra Picture or keyframe, is an important frame in inter-frame compression coding. It is a full-frame compressed encoded frame that can be used to reconstruct a complete image with only the data of the I frame during decoding. The I frame does not need to refer to other frames to generate it. Moving Picture Experts Group (MPEG) encoding divides the picture (i.e., frame) into three types: I frame, P frame, and B frame. I frame is an internal encoded frame, P frame is a forward prediction frame, and B frame is a bidirectional internal frame interpolation. In short, I frame is a keyframe, which can be understood as a complete picture, while P frame and B frame record the changes relative to the I frame. P frame represents the difference from the previous frame, and B frame represents the difference between the before and after frames. Without I frame, P frame and B frame cannot be decoded.

Group of Pictures (GOP): A GOP is a continuous group of pictures. The first image of the GOP must be an I frame.

Frame Rate: The frequency at which images appear continuously on the display in frames. The frame rate is usually measured in frames per second (fps). The more frames per second, the smoother the displayed action will be. The minimum frame rate that the human eye can accept during the game is 30 fps, and the basic smoothness level needs to be >60 fps.

Embodiments of the present disclosure can be applied to scenarios involving Streaming Media applications including, but not limited to, network LIVE applications, film and television applications, Cloud Gaming applications, etc. For case of understanding, the following Cloud Gaming scenario as an example, the application scenarios of the disclosed embodiment will be introduced.

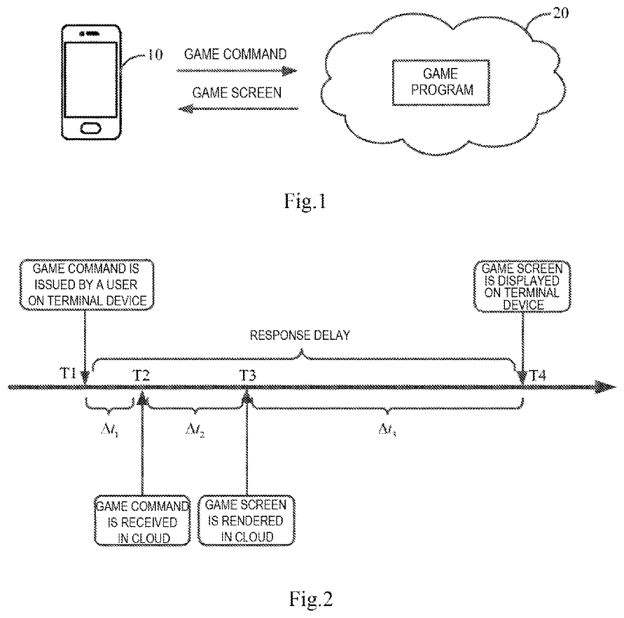

FIG. 1 is a schematic diagram of the Cloud Gaming scenario provided in embodiments of the present disclosure. As shown in FIG. 1, the application scenario includes a terminal device 10 and a cloud server 20. The terminal device 10 and the cloud server 20 are connected through a network. The game program runs on the cloud server 20, and the user issues game instructions through the terminal device 10 to control the game program on the cloud server 20. The cloud server 20 renders and generates game screens according to the game instructions and sends the game screen to the terminal device 10 for display, so that the user can watch the game screen through the terminal device 10. In the application scenario shown in FIG. 1, since the game program runs on the cloud server, users can enjoy high-quality games anytime and anywhere using the hardware resources provided by the cloud server, without the need to purchase expensive game hardware resources for the terminal device, reducing hardware requirements for the terminal device.

The terminal device 10 is an electronic device to provide user interaction, including but not limited to: smart phones, platform computers, laptops, smart TVs, game controllers, smart wearable devices.

Cloud gaming application scenarios have strict requirements for response latency. Response delay refers to the time between the user issuing a game command through the terminal device and the user seeing the game screen on the terminal device screen. FIG. 2 is a schematic diagram of the response delay in the cloud gaming scenario provided by the present public embodiment. As shown in FIG. 2, assuming that the user issues a game command by the terminal device at time T1, the cloud server receives the game command at time T2, the cloud server renders the game screen at time T3, and the game screen is displayed on the screen of the terminal device at time T4.

In the above example, the time between time T1 and time T2 is the time required for the game instructions to be transmitted from the terminal device to the cloud server. The time between time T2 and time T3 is the time required for the cloud server to render the game screen according to the game instructions. The time between time T3 and time T4 is the time required for the game screen to be transmitted from the cloud server to the terminal device. Therefore, the response delay is equal to the sum of the above three lengths of time. As shown in FIG. 2, a large part of the response delay comes from the time required to transmit the game screen from the cloud server to the terminal device.

If the response delay is large, the user would feel that the game is stuck. Usually, the response delay needs to be controlled within 100 ms to prevent the user from feeling stuck. In related technologies, the following methods can be used to reduce the response delay:

(1) Users are required to use high-quality network access services with high bandwidth and low latency.

(2) Reasonable layout of cloud servers, so that the network connection between user terminal devices and cloud servers has low latency.

(3) Optimize the data transmission process, for example, reduce the data cache used in the data transmission process, optimize the transmission protocol, and minimize transmission delay.

However, the inventors found during the research process that the network path between the terminal device and the cloud server may be congested, and the above related technologies still have the problem of high response delay in the event of network congestion. For example, the Router on the network path between the terminal device and the cloud server may be congested at any time due to changes in background traffic. Such congestion is neither controllable nor predictable. Therefore, once network congestion occurs, users are likely to feel that the game screen is stuck or the response of game instructions is not timely, which affects the user's gaming experience.

In order to solve the above problems, embodiments of the present disclosure provide a method, apparatus, apparatus, electronic device, computer readable storage medium, computer program product and a computer program for data transmission. The cloud server may transmit target media data to the terminal device on at least two physical transmission paths. As such, in a case where network congestion occurs in a physical transmission path, the media data transmitted on other physical transmission path(s) is not affected, the terminal device may also be displayed according to the received media data through other physical transmission paths, thereby ensuring a lower response delay, improve user experience.

The following embodiments of the present disclosure will be described in detail. The following several specific embodiments may be combined with each other, for the same or similar concepts or processes may not be repeated in some embodiments.

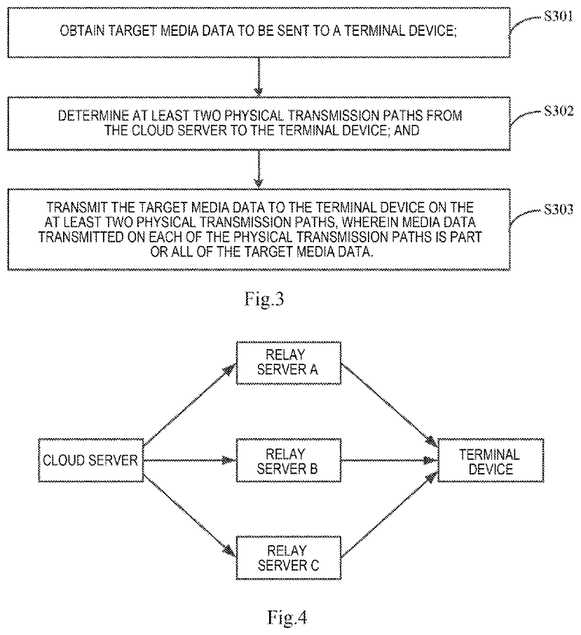

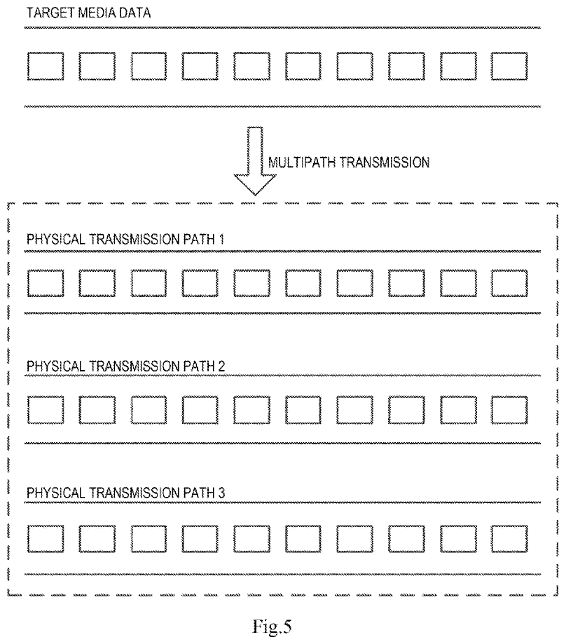

FIG. 3 is a schematic flow diagram of a method for data transmission provided in embodiments of the present disclosure. The method of the present embodiment can be performed by a cloud server. As shown in FIG. 3, the method of the present embodiment includes:

S301: obtain target media data to be transmitted to the terminal device.

In embodiments of the present disclosure, the target media data is transmitted between the cloud server and the terminal device using streaming media technology. That is to say, the cloud server transmits the target media data in a streaming manner in the network segments to the terminal device, so that the terminal device achieves real-time play back of the target media data display.

The target media data can be in the form of video data. In other words, the target media data can include multiple image frames. The target media data can also be in the form of audio data.

In different application scenarios, the form and content of the target media data may be different. For example, in a network live scenario, the target media data can be live video data. In a film and television application scenario, the target media data can be film and television images. In a Cloud Gaming scenario, the target media data can be game screen data.

Optionally, in the cloud gaming scenario, block S301 may also comprise receiving game instructions from the terminal device. Block S301 may comprises rendering and generating game images based on game instructions, which are target media data to be sent to the terminal device.

S302: determine at least two physical transmission paths from the cloud server to the terminal device.

S303: transmit the target media data to the terminal device on the at least two physical transmission paths; wherein the media data transmitted on each physical transmission path is a part or all of the target media data.

In embodiments herein, the method of transmitting the target media data to the terminal device through at least two physical transmission paths can be called “multipath transmission”. In the existing cloud gaming scenario, the usual practice is to use single-path transmission, that is, only one physical transmission path is established. The cloud server transmits the target media data to the terminal device through this physical transmission path. Therefore, when network congestion occurs on this physical transmission path, the response delay is inevitably too high. In embodiments herein, by using multipath transmission, when one of the physical transmission paths is congested, the media data transmitted by other physical transmission paths is not affected, and the terminal device can also display the media data received through other physical transmission paths, thereby ensuring a lower response delay and improving user experience.

Prior to execution of the embodiments herein, a plurality of physical transmission paths from the cloud server to the terminal device can be established in advance (i.e., multipath creation). Thus, in embodiments of the present disclosure, at least two physical transmission paths may be selected from the plurality of physical transmission paths, and the target media data is to transmitted to the terminal device on the selected at least two physical transmission paths.

It should be understood that the selected at least two physical transmission paths may be all of the plurality of physical transmission paths established in advance, or a part of the plurality of physical transmission paths established in advance. For example, assuming that three physical transmission paths from the cloud server to the terminal device are established in advance, in embodiments of the present disclosure, target media data may be transmitted to the terminal device on the three physical transmission paths or any two of the physical transmission paths.

In embodiments of the present disclosure, when transmitting the target media data to the terminal device on the at least two physical transmission paths, the media data transmitted on each physical transmission path may be part or all of the target media data.

For example, considering two physical transmission paths as an example, there are a first physical transmission path and a second physical transmission path. In one example, a part of the target media data can be transmitted on the first physical transmission path, and the other part of the target media data can be transmitted on the second physical transmission path. In another example, all of the target media data can be transmitted on the first physical transmission path, and all of the target media data can be transmitted on the second physical transmission path. In another example, a part of the target media data can be transmitted on the first physical transmission path, and all of the target media data can be transmitted on the second physical transmission path.

It should be noted that a physical transmission path in the embodiments herein refers to a physical transmission path instead of a logical transmission path. A “physical transmission path” refers to the network path formed by connecting different network devices (such as routers, servers, etc.) through network transmission media (such as optical fibers, network cables, wireless transmission paths, etc.). A “logical transmission path” refers to a network path established at the application level based on different network transmission protocols.

For example, by establishing two Transmission Control Protocol (TCP) based connections between a cloud server and a terminal device, or by establishing a TCP-based connection and a User Datagram Protocol (UDP) based connection, the two established transmission paths belong to the logical level transmission path, rather than the physical level transmission path. Although the two established transmission paths are logically independent and do not interfere with each other, they still transmit data in the same physical transmission path, so they cannot be considered as two physical transmission paths.

In practice, the plurality of physical transmission paths between the cloud server and the terminal device can be created in a variety of ways, and the present disclosure is not limited in this regard. The following several possible implementations as an example.

In one possible implementation, a plurality of physical transmission paths can be created by means of a relay server. FIG. 4 is a schematic diagram of a plurality of physical transmission paths provided by the embodiments of the present disclosure. As shown in FIG. 4, three physical transmission paths can be created with by means of a relay server A, a relay server B, and a relay server C. A first physical transmission path is from the cloud server to the relay server A and then from the relay server A to the terminal device. A second physical transmission path is from the cloud server to the relay server B, and then from the relay server B to the terminal device. A third physical transmission path is from the cloud server to the relay server C and then from the relay server C to the terminal device. In this way, the cloud server can transmit target media data to the terminal device on at least two of the above three physical transmission paths.

Another possible implementation method is to use routing and addressing technology based on Internet Protocol (IP) to create a plurality of physical transmission paths. It should be noted that this approach usually requires special support from network operators to ensure multiple physical transmission paths.

In another possible implementation, in the absence of special support from network operators, the above IP-based routing addressing technology and the use of relay servers can be combined to create multiple physical transmission paths.

In another possible implementation, if the terminal device supports different network interfaces at the same time, such as supporting both a Wireless Fidelity (Wi-Fi) interface and a 5th Generation Mobile Communication Technology (5G) interface or supporting both a Wi-Fi interface and a 4G interface, multiple physical transmission paths can be created using different network interfaces. The possibility of overlapping multiple physical transmission paths established in this way is low, and it is more convenient to implement.

After establishing a plurality of physical transmission paths, it is usually necessary to detect the bandwidth and delay of each of the physical transmission paths to ensure that each physical transmission path can meet the requirements of the application scenario. In addition, it should be noted that in the embodiments herein, different physical transmission paths allow for partial overlap, but not complete overlap. Optionally, after establishing multiple physical transmission paths, the degree of overlap of each physical transmission path can also be analyzed. In this way, when multipath transmission is required, assuming other conditions are similar, physical transmission paths with low overlap should be selected for use as much as possible.

In addition, it should be noted that in some scenarios, the transmission path in the transmission direction from the terminal device to the cloud server (referred to as “download direction” hereinafter) is different from the transmission path in the transmission direction from the cloud server level to the terminal device (referred to as “upload direction” hereinafter), and this situation is not “multipath” as described in the present disclosure. “Multipath” in the present disclosure means that there are at least two physical transmission paths in the download direction. The present disclosure does not limit the transmission path in the upload direction. The transmission path in the upload direction can multiplex a part or all of the transmission path in the download direction, and other transmission paths can also be multiplexed. The present disclosure does not limit this.

The method for data transmission provided by the embodiments herein comprises: a cloud server obtains target media data to be sent to a terminal device, determines at least two physical transmission paths from the cloud server to the terminal device, and transmits the target media data to the terminal device on the at least two physical transmission paths; wherein the media data transmitted on each physical transmission path is part or all of the target media data. In this way, multipath transmission is realized. When network congestion occurs on one physical transmission path, the media data transmitted by other physical transmission paths is not affected, and the terminal device can also display the media data received through other physical transmission paths, thereby ensuring lower response delay and improving user experience.

In some application scenarios, due to the fact that the target media data is usually in the form of video or audio data, the amount of data in the target media data is large. In order to facilitate transmission, it is necessary to encode and compress the target media data before sending it.

Specifically, the cloud server uses a predetermined encoding algorithm to encode the target media data to obtain the encoded data and transmits the encoded data to the terminal device. After receiving the encoded data, the terminal device uses a corresponding decoding algorithm to decode the encoded data to obtain the target media data and then displays the target media data.

In the single-path transmission mode, since the target media data is transmitted in the same physical transmission path, only the image frames in the target media data can be sequentially encoded during encoding. In the multipath transmission mode provided in the present disclosure, the target media data may be divided into a plurality of parts, and different parts are transmitted on different physical transmission paths. Therefore, the cloud server also needs to adjust the encoding mode of the target media data to adapt to the multipath transmission mode.

In embodiments of the present disclosure, the cloud server may be implemented in the following manner multipath transmission:

(1) Determine the respective media data to be transmitted corresponding to the at least two physical transmission paths based on the target media data.

When the target media data comprises a plurality of image frames, it is necessary to determine the image frame(s) corresponding to each physical transmission path from the multiple image frames.

Optionally, the image frames corresponding to different physical transmission paths can be exactly the same, for example, the image frames corresponding to each physical transmission path comprise all image frames in the plurality of image frames.

Optionally, the image frames corresponding to different physical transmission paths can be partially the same. Considering a first and a second physical transmission paths as an example, the image frames corresponding to the first physical transmission path comprise all image frames from the plurality of image frames, and the image frames corresponding to the second physical transmission path comprise some image frames from the plurality of image frames.

Optionally, the image frames corresponding to different physical transmission paths can be completely different. Considering the first and second physical transmission paths as an example, the plurality of image frames can be divided into a first group of image frames and a second group of image frames. The image frames corresponding to the first physical transmission path comprise the first group of image frames, and the image frames corresponding to the second physical transmission path comprise the second group of image frames.

(2) Encode the media data to be transmitted corresponding to each physical transmission path to obtain the encoded data corresponding to that physical transmission path.

It should be understood that the present disclosure is not limited to any encoding algorithm, and conventional video encoding algorithms can be utilized.

(3) Transmit the respective encoded data on the at least two physical transmission paths to the terminal device.

In the above process, due to the independent encoding processing of the media data to be transmitted corresponding to each physical transmission path, the encoded data corresponding to different physical transmission paths are independent of each other. The terminal device can independently decode the encoded data corresponding to each physical transmission path without relying on the encoded data corresponding to other physical transmission paths. In this way, when one of the physical transmission paths experiences network congestion, the media data transmitted by other physical transmission paths is not affected, and the terminal device can still decode and display the media data transmitted by other physical transmission paths, thereby ensuring lower response delay and improving user experience.

Below, several specific examples are combined to provide a more detailed introduction to the multipath transmission scheme provided in this disclosure.

### Multipath Transmission Scheme 1

The cloud server determines the target media data as the media data to be transmitted corresponding to each physical transmission path. In other words, the cloud server encodes the target media data to obtain the first encoded dat and sends the first encoded data to the terminal device through each physical transmission path. In this way, the same data is transmitted in multiple physical transmission paths.

FIG. 5 is a schematic diagram of a multipath transmission provided in embodiments of the present disclosure. As shown in FIG. 5, considering three physical transmission paths as an example, the cloud server encodes the target media data to obtain the first encoded data, and sends the first encoded data to the terminal device on each physical transmission path. In this implementation, all target media data is transmitted on each physical transmission path, so that multiple physical transmission paths achieve the effect of redundant backup. When network congestion occurs in one of the physical transmission paths, the terminal device can decode and display the first encoded data transmitted on another physical transmission path, thereby ensuring lower response delay and improving user experience.

It should be noted that in this implementation, the encoding method of the target media data by the cloud server can adopt the encoding method in single-path transmission, that is, sequentially encoding each image frame in the target media data.

It will be appreciated that the multipath transmission mode shown in FIG. 5, suitable for media data in the form of audio, or for a lower bit rate, bandwidth-rich video form of media data.

### Multipath Transmission Scheme 2

It is assumed that two physical transmission paths are used for multipath transmission: the first physical transmission path and the second physical transmission path, respectively. The cloud server can determine all image frames from the plurality of image frames as image frames corresponding to the first physical transmission path and determine some image frames from the plurality of image frames as image frames corresponding to the second physical transmission path. In this way, some of the image frames transmitted on the two physical transmission paths are the same.

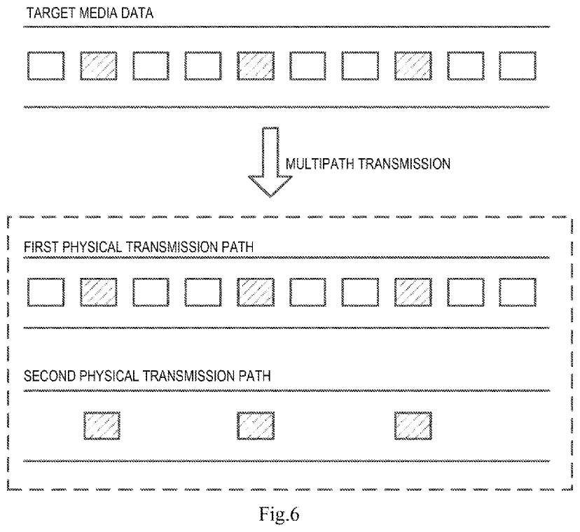

FIG. 6 is a schematic diagram of another multipath transmission provided in embodiments of the present disclosure. As shown in FIG. 6, considering two physical transmission paths as an example, the cloud server transmits all image frames in the target media data on the first physical transmission path and transmits some image frames in the target media data on the second physical transmission path.

In one possible implementation, SVC hierarchical coding can be used to process multiple image frames included in the target media data in layers to obtain different levels, such as L1 and L2 layers. The L1 layer corresponds to the underlying bitstream, and the L1 layer can be decoded separately to obtain basic video data. The L2 layer corresponds to the upper layer bitstream, and decoding the L2 layer can enhance video quality. In this way, the image frames of the L1 layer and L2 layer can be transmitted on the first physical transmission path, and the image frames of the L1 layer can be transmitted on the second physical transmission path. Assuming network congestion occurs in the first physical transmission path, the terminal device can decode the basic video data based on the L1 layer data transmitted on the second physical transmission path. Assuming network congestion occurs in the second physical transmission path, the terminal device can decode the L1+L2 layer data transmitted based on the first physical transmission path to obtain high-quality video data. It can be seen that no matter which physical transmission path experiences network congestion, it will not affect the response delay.

### Multipath Transmission Scheme 3

The cloud server groups the plurality of image frames included in the target media data according to the number of physical transmission paths, and each physical transmission path transmits a group of image frames. In this way, the image frames transmitted on the plurality of physical transmission paths are different from each other.

In one possible implementation, assuming that the number of physical transmission paths is K, for the i-th physical transmission path, it can be determined that the image frames corresponding to the i-th physical transmission path comprise the i-th, (i+K)-th, (i+2*K)-th . . . , and (i+n*K)-th image frames, where n is the maximum value satisfying i+n*K≤L, and L is the number of the plurality of image frames.

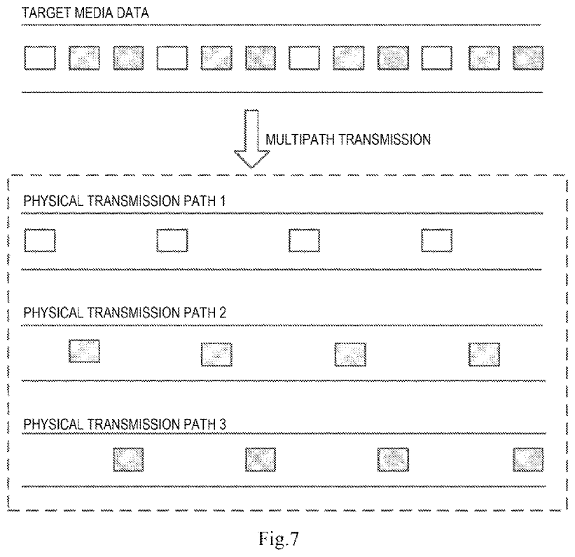

As an example, FIG. 7 is a schematic diagram of another multipath transmission provided by the present disclosure. As shown in FIG. 7, it is assumed that the target media data comprises 12 image frames. If the number of physical transmission paths is 3, then:

The image frames corresponding to the physical transmission path 1 include: the first, fourth, seventh, and tenth image frames. After encoding the above four image frames, they are transmitted on the physical transmission path 1.

The image frames corresponding to the physical transmission path 2 include: the second, fifth, eighth, and eleventh image frames. After encoding the above four image frames, they are transmitted on the physical transmission path 2.

The image frames corresponding to the physical transmission path 3 include: the third, sixth, ninth, and twelfth image frames. After encoding the above four image frames, they are transmitted on the physical transmission path 3.

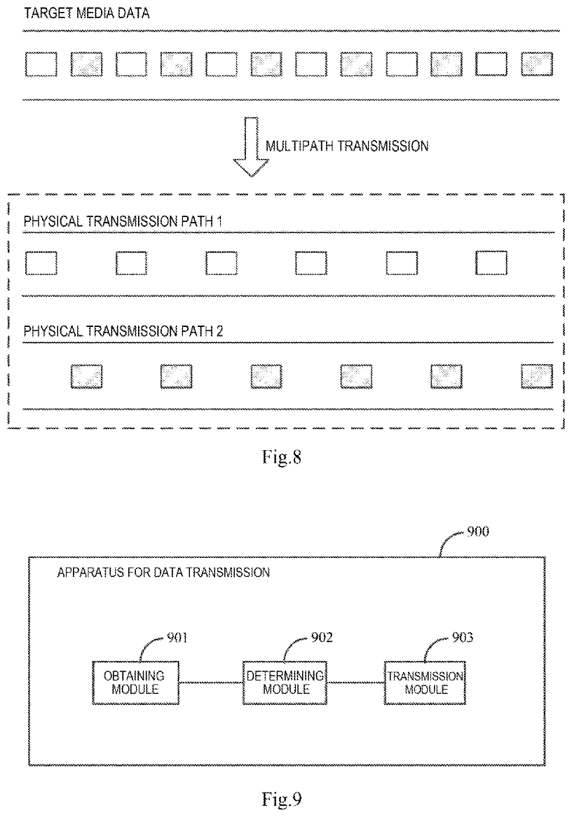

As another example, FIG. 8 is a schematic diagram of another multipath transmission provided by the present disclosure. As shown in FIG. 8, assuming that the target media data includes 12 image frames, if the number of physical transmission paths is 2, they can be grouped according to the parity of the image frame number. That is:

The image frames corresponding to the physical transmission path 1 include: the first, third, fifth, seventh, ninth, and eleventh image frames. After encoding the above six image frames, they are transmitted on the physical transmission path 1.

The image frames corresponding to the physical transmission path 2 include: the second, fourth, sixth, eighth, tenth, and twelfth image frames. After encoding the above six image frames, they are transmitted on the physical transmission path 2.

In the examples shown in FIGS. 7 and 8 above, when the network of each physical transmission path is in a normal state, the image frames transmitted from each physical transmission path will arrive at the terminal device in sequence, and the terminal device will decode the image frames received from each physical transmission path and broadcast them in sequence, user experience is no different from the existing single-path transmission scheme.

When one of the physical transmission paths is congested, for example, the physical transmission path 1 in FIG. 8 is congested, causing the image frames corresponding to the physical transmission path 1 not to be sent to the terminal device on time. However, the network status of the physical transmission path 2 is normal, and the image frames corresponding to the physical transmission path 2 are received by the terminal device on time. Therefore, the terminal device can play the image frames received by the physical transmission path 2 in sequence without waiting for the image frames corresponding to the physical transmission path 1. In this way, from the perspective of user experience, the video screen will not experience lag. If the frame rate of the original video is 60 fps, the video frame rate restored from a single physical transmission path can also reach 30 fps. In most scenarios, users are not easily affected by frame drops.

It can be seen that by grouping the image frames in the target media data at intervals, the image frames in the target media data are uniformly dispersed on each physical transmission path, on the one hand, the data amount of each physical transmission path is balanced, and on the other hand, When network congestion occurs in one of the physical transmission paths, the terminal device Decodes and displays the data in the other physical transmission paths, and obvious Caton does not occur.

On the basis of the above multipath transmission scheme 3, the encoded data corresponding to each physical transmission path includes a key frame(s) and a non-key frame(s), and the positions of the key frames corresponding to different physical transmission paths are different. The above key frames can be I frames, and the above non-key frames can include P frames and B frames.

Considering FIG. 8 as an example, when independently encoding the image frames corresponding to physical transmission path 1 and physical transmission path 2, it is necessary to try to stagger the I frame corresponding to the two physical transmission paths as much as possible. For example, GOP usually has a value of 30, that is, one I frame is generated every 30 frames. By adjusting the encoder, image frames 1, 61, 121, etc. on the physical transmission path I can be used as I frames. and image frames 16, 76, 136, etc. on physical transmission path 2 can be used as I frames. Such a misalignment can prevent the two physical transmission paths from receiving I frames at the same time, thereby avoiding additional delay caused by the two physical transmission paths receiving larger I frames at the same time. Even if one physical transmission path misses the playback window because of receiving I frames, the other physical transmission path can directly play the next frame, thereby avoiding the lag caused by too large I frames.

In one possible implementation, the cloud server can also determine the network quality corresponding to at least two physical transmission paths, and then determine the image frames corresponding to each physical transmission path from multiple image frames included in the target media data according to the network quality corresponding to at least two physical transmission paths.

Optionally, assuming that the at least two physical transmission paths include a first physical transmission path and a second physical transmission path, when the network quality corresponding to the first physical transmission path is better than that corresponding to the second physical transmission path, the number of image frames corresponding to the first physical transmission path is greater than the number of image frames corresponding to the second physical transmission path.

That is to say, in practice, if there are differences in the network quality corresponding to the respective physical transmission paths, for example, a certain physical transmission path is more prone to jitter or packet loss, the numbers of image frames corresponding to the respective physical transmission paths can be adjusted to send more image frames to the physical transmission path with better network quality. In this way, through the above dynamic adjustment process, the possibility of high response delay caused by network congestion can be minimized to the greatest extent.

In addition, it should be noted that in this embodiment, although the image frames corresponding to each physical transmission path are independently encoded, the encoder needs to coordinate the encoding parameters corresponding to different physical transmission paths. For example. when the encoder encodes, it is necessary to ensure that the values of the quantization parameter (QP) corresponding to each physical transmission path are as close as possible. In this way, it can be ensured that the image quality presented at the terminal device will not have too much jump due to the image frames coming from different physical transmission paths.

FIG. 9 is a schematic diagram of the structure of an apparatus for data transmission provided in embodiments of the present disclosure. The device may be in the form of software and/or hardware, and the device may be a cloud server or a device provided in the cloud server. As shown in FIG. 9, the apparatus for data transmission 900 provided in embodiments of the present disclosure may comprise an obtaining module 901, a determining module 902, and a transmission module 903.

The obtaining module 901 is configured to obtain target media data to be sent to a terminal device.

The determining module 902 is configured to determine at least two physical transmission paths from the cloud server to the terminal device.

The transmission module 903 is configured to transmit the target media data to the terminal device on the at least two physical transmission paths, wherein media data transmitted on each of the physical transmission paths is part or all of the target media data.

In one possible implementation, the transmission module 903 is specifically configured to: determine respective media data to be transmitted corresponding to the at least two physical transmission paths according to the target media data; encode the media data to be transmitted corresponding to each of the physical transmission paths to obtain the encoded data corresponding to the physical transmission path; and transmit the respective encoded data on the at least two physical transmission paths to the terminal device.

In one possible implementation, the target media data comprises a plurality of image frames; the transmission module 903 is specifically configured to determine respective image frames corresponding to the at least two physical transmission paths from the plurality of image frames.

In one possible implementation, the number of the at least two physical transmission paths is K, and for the i-th physical transmission path where i is an integer less than or equal to K, and the transmission module 903 is specifically configured to determine that the image frames corresponding to the first physical transmission path comprise the i-th, (i+K)-th, (i+2*K)-th . . . , and (i+n*K)-th image frames from the plurality of image frames, wherein n is the maximum value satisfying i+n*K≤L, and L is the number of the plurality of image frames.

In one possible implementation, the encoded data corresponding to each physical transmission path includes a key frame(s) and a non-key frame(s), and the positions of the key frames in the encoded data corresponding to different physical transmission paths are different.

In one possible implementation, the transmission module 903 is specifically configured to determine network quality corresponding to the at least two physical transmission paths; and determine the respective image frames corresponding to the at least two physical transmission paths from the plurality of image frames based on the network quality corresponding to the at least two physical transmission paths.

In one possible implementation, the at least two physical transmission paths include a first physical transmission path and a second physical transmission path. If the network quality corresponding to the first physical transmission path is better than the network quality corresponding to the second physical transmission path, a number of the image frames corresponding to the first physical transmission path is greater than a number of the image frames corresponding to the second physical transmission path.

In one possible implementation, the at least two physical transmission paths include a first physical transmission path and a second physical transmission path; the transmission module 903 is specifically configured to determine all image frames in the plurality of image frames as the image frames corresponding to the first physical transmission path; and determine a part of the image frames in the plurality of image frames as the image frames corresponding to the second physical transmission path.

In one possible implementation, the transmission module 903 is specifically configured to determine the target media data as the media data to be transmitted corresponding to each of the physical transmission paths.

The apparatus for data transmission as provided in embodiments of the present disclosure can be used to perform the method for data transmission as described in any of the above embodiments. The implementation principles and technical effects are similar and will not repeated herein.

To implement the above embodiments, the present disclosure further provides an electronic device.

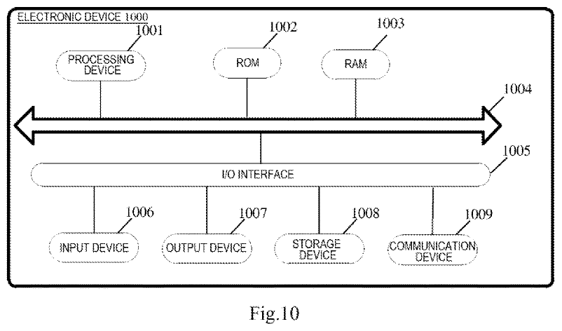

Referring to FIG. 10, which shows a schematic structural diagram of an electronic device 1000 suitable for implementing the present disclosure, the electronic device 1000 may be a terminal device or a server. The terminal device may include but is not limited to mobile terminals such as mobile phones, laptops, digital broadcast receivers, personal digital assistants (PDAs), tablet computers (Portable Android Devices, referred to as PAD), portable multimedia players (Portable Media Player, referred to as PMP), car-mounted terminals (such as car navigation terminals), and fixed terminals such as digital TVs, desktop computers, etc. The electronic device shown in FIG. 10 is only an example and should not bring any limitation on the functionality and scope of use of the present disclosure.

As shown in FIG. 10, the electronic device 1000 may include a processing device (such as a Central Processor, graphics processing unit, etc.) 1001, which can perform various appropriate actions and processes based on programs stored in Read Only Memory (ROM) 1002 or programs loaded from storage device 1008 into Random Access Memory (RAM) 1003. In RAM 1003, various programs and data required for the operation of the electronic device 1000 are also stored. The processing device 1001, ROM 1002, and RAM 1003 are connected to each other through a bus 1004. The input/output (I/O) interface 1005 is also connected to the bus 1004.

Typically, the following devices can be connected to the I/O interface 1005: input devices 1006 including touch screens, touchpads, keyboards, mice, cameras, microphones, accelerometers, gyroscopes, etc.; output devices 1007 including liquid crystal displays (LCDs), speakers, vibrators, etc.; storage devices 1008 including magnetic tapes. hard disks, etc.; and communication devices 1009. Communication devices 1009 can allow electronic devices 1000 to communicate wirelessly or wirelessly with other devices to exchange data. Although FIG. 10 shows an electronic device 1000 with various devices, it should be understood that it is not required to implement or have all of the devices shown. More or fewer devices can be implemented or provided instead.

In particular, according to embodiments of the present disclosure, the process described above with reference to the flowchart may be implemented as a computer software program. For example, embodiments of the present disclosure include a computer program product comprising a computer program carried on a computer-readable medium, the computer program comprising program code for performing the method shown in the flowchart. In such embodiments, the computer program may be downloaded and installed from the network via the communication device 1009, or installed from the storage device 1008, or installed from the ROM 1002. When the computer program is executed by the processing device 1001, the above-described functions defined in the method of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, device, or device, or any combination thereof. More specific examples of computer-readable storage media can include but are not limited to: electrical connections with one or more wires, portable computer disks, hard disks, RAM, ROM, erasable programmable read-only memory (EPROM or flash memory for short), optical fibers, portable compact disk read-only memory (CD-ROM for short), optical storage devices, magnetic storage devices, or any suitable combination thereof. In this disclosure, the computer-readable storage medium can be any tangible medium that contains or stores programs that can be used by or in conjunction with instruction execution systems, devices, or devices. In this disclosure, computer-readable signal media can include data signals propagated in baseband or as part of a carrier wave, which carry computer-readable program code. Such propagated data signals can take many forms, including but not limited to electromagnetic signals, optical signals, or any suitable combination thereof. Computer-readable signal media can also be any computer-readable medium other than computer-readable storage media, which can send, propagate, or transmit programs for use by or in combination with instruction execution systems, devices, or devices. The program code contained on the computer-readable medium can be transmitted using any suitable medium, including but not limited to: wires, optical cables, radio frequency (RF), etc., or any suitable combination thereof.

The computer-readable medium can be included in the electronic device, or it can exist alone without being assembled into the electronic device.

The computer-readable medium carries one or more programs, when the one or more programs are executed by the electronic device, so that the electronic device performs the method shown in the above embodiment.

Computer program code for performing the operations of the present disclosure may be written in one or more programming languages, or combinations thereof, including Object Oriented programming languages such as Java. Smalltalk. C++, as well as conventional procedural programming languages such as “C” or similar programming languages. The program code may be executed entirely on the user's computer, partially on the user's computer, as a standalone software package, partially on the user's computer, partially on the remote computer, or entirely on the remote computer or server. In the case of a remote computer, the remote computer may be connected to the user's computer via any type of network, including a local area network (LAN) or a wide area network (WAN), or may be connected to an external computer (e.g., via the Internet using an Internet service provider).

The flowcharts and block diagrams in the accompanying drawings illustrate the architecture. functions, and operations of systems, methods, and computer program products that may be implemented in accordance with various embodiments of the present disclosure, in this regard, each block in the flowchart or block diagram may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in reverse order, depending on the function involved. It should also be noted that each block in the block diagram and/or flowchart, and combinations of blocks in the block diagram and/or flowchart, may be implemented using a dedicated hardware-based system that performs the specified function or operation, or may be implemented using a combination of dedicated hardware and computer instructions.

The units described in the disclosed embodiments may be implemented by means of software or by means of hardware, wherein the name of the unit does not constitute a limitation on the unit itself under certain circumstances, for example, the first acquisition unit may also be described as “a unit that acquires at least two Internet protocol addresses.”

The functions described above in this article can be performed at least in part by one or more hardware logic components. For example, without limitation, exemplary types of hardware logic components that can be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, RAM, ROM, EPROM, optical fibers, CD-ROMs, optical storage devices, magnetic storage devices, or any suitable combination thereof.

In a first aspect, according to one or more embodiments of the present disclosure, there is provided a method for data transmission applied to a cloud server, the method comprising: obtaining target media data to be sent to a terminal device; determining at least two physical transmission paths from the cloud server to the terminal device; and transmitting the target media data to the terminal device on the at least two physical transmission paths, wherein media data transmitted on each of the physical transmission paths is part or all of the target media data.

According to one or more embodiments of the present disclosure, transmitting the target media data the terminal device on the at least two physical transmission paths comprises: determining respective media data to be transmitted corresponding to the at least two physical transmission paths according to the target media data; encoding the media data to be transmitted corresponding to each of the physical transmission paths to obtain the encoded data corresponding to the physical transmission path; and transmitting the respective encoded data on the at least two physical transmission paths to the terminal device.

According to one or more embodiments of the present disclosure, the target media data comprises a plurality of image frames, and determining respective media data to be transmitted corresponding to the at least two physical transmission paths according to the target media data comprises: determining respective image frames corresponding to the at least two physical transmission paths from the plurality of image frames.

According to one or more embodiments of the present disclosure, the number of the at least two physical transmission paths is K, and for the i-th physical transmission path where i is an integer less than or equal to K, and determining the image frame corresponding to the i-th physical transmission path comprises: determining that the image frames corresponding to the first physical transmission path comprise the i-th, (i+K)-th, (i+2*K)-th . . . , and (i+n*K)-th image frames from the plurality of image frames, wherein n is the maximum value satisfying i+n*K≤L, and L is the number of the plurality of image frames.

According to one or more embodiments of the present disclosure, the encoded data corresponding to each of the physical transmission paths comprises a key frame and a non-key frame, and positions of the key frames in the encoded data corresponding to different physical transmission paths are different.

According to one or more embodiments of the present disclosure, determining respective image frames corresponding to the at least two physical transmission paths from the plurality of image frames comprises: determining network quality corresponding to the at least two physical transmission paths; and determining the respective image frames corresponding to the at least two physical transmission paths from the plurality of image frames based on the network quality corresponding to the at least two physical transmission paths.

According to one or more embodiments of the present disclosure, the at least two physical transmission paths comprise a first and a second physical transmission paths. If the network quality corresponding to the first physical transmission path is better than the network quality corresponding to the second physical transmission path, a number of the image frames corresponding to the first physical transmission path is greater than a number of the image frames corresponding to the second physical transmission path.

According to one or more embodiments of the present disclosure, the at least two physical transmission paths comprise a first and a second physical transmission paths, and determining respective image frames corresponding to the at least two physical transmission paths from the plurality of image frames comprises: determining all image frames in the plurality of image frames as the image frames corresponding to the first physical transmission path; and determining a part of the image frames in the plurality of image frames as the image frames corresponding to the second physical transmission path.

According to one or more embodiments of the present disclosure, determining respective media data to be transmitted corresponding to the at least two physical transmission paths according to the target media data comprises: determining the target media data as the media data to be transmitted corresponding to each of the physical transmission paths.

In a second aspect, according to one or more embodiments of the present disclosure, there is provided an apparatus for data transmission applied to a cloud server, the apparatus comprising: an obtaining module configured to obtain target media data to be sent to a terminal device; a determining module configured to determine at least two physical transmission paths from the cloud server to the terminal device; and a transmission module configured to transmit the target media data to the terminal device on the at least two physical transmission paths, wherein media data transmitted on each of the physical transmission paths is part or all of the target media data.

According to one or more embodiments of the present disclosure, the transmission module is specifically configured to: determine respective media data to be transmitted corresponding to the at least two physical transmission paths according to the target media data; encode the media data to be transmitted corresponding to each of the physical transmission paths to obtain the encoded data corresponding to the physical transmission path; and transmit the respective encoded data on the at least two physical transmission paths to the terminal device.

According to one or more embodiments of the present disclosure, the target media data comprises a plurality of image frames; and the transmission module is specifically configured to determine respective image frames corresponding to the at least two physical transmission paths from the plurality of image frames.

According to one or more embodiments of the present disclosure, the number of the at least two physical transmission paths is K, and for the i-th physical transmission path where i is an integer less than or equal to K, and the transmission module is specifically configured to determine that the image frames corresponding to the first physical transmission path comprise the i-th, (i+K)-th, (i+2*K)-th . . . , and (i+n*K)-th image frames from the plurality of image frames, wherein n is the maximum value satisfying i+n*K≤L, and L is the number of the plurality of image frames.

According to one or more embodiments of the present disclosure, the encoded data corresponding to each physical transmission path includes a key frame(s) and a non-key frame(s), and the positions of the key frames in the encoded data corresponding to different physical transmission paths are different.

According to one or more embodiments of the present disclosure, the transmission module is specifically configured to determine network quality corresponding to the at least two physical transmission paths; and determine the respective image frames corresponding to the at least two physical transmission paths from the plurality of image frames based on the network quality corresponding to the at least two physical transmission paths.

According to one or more embodiments of the present disclosure, the at least two physical transmission paths include a first physical transmission path and a second physical transmission path. If the network quality corresponding to the first physical transmission path is better than the network quality corresponding to the second physical transmission path, a number of the image frames corresponding to the first physical transmission path is greater than a number of the image frames corresponding to the second physical transmission path.

According to one or more embodiments of the present disclosure, the at least two physical transmission paths include a first physical transmission path and a second physical transmission path; the transmission module is specifically configured to determine all image frames in the plurality of image frames as the image frames corresponding to the first physical transmission path; and determine a part of the image frames in the plurality of image frames as the image frames corresponding to the second physical transmission path.

According to one or more embodiments of the present disclosure, the transmission module is specifically configured to determine the target media data as the media data to be transmitted corresponding to each of the physical transmission paths.

In a third aspect, embodiments of the present disclosure provide an electronic device, comprising: a processor and a memory. The memory stores computer-executable instructions. The processor executes the computer-executable instructions to implement the method for data transmission as described in the first aspect and various possible designs thereof.

In a fourth aspect, embodiments of the present disclosure provide a computer-readable storage medium. The computer-readable storage medium stores computer-executable instructions that, when executed by a process, implement the method for data transmission as described in the first aspect and various possible designs thereof.

In a fifth aspect, embodiments of the present disclosure provide a computer program product comprising a computer program. The computer program, when executed by a processor, implements the method for data transmission as described in the first aspect and various possible designs thereof.

In a sixth aspect, embodiments of the present disclosure provide a computer program. The computer program, when executed by a processor, implements the method for data transmission as described in the first aspect and various possible designs thereof.

The above description is only the preferred embodiment of the present disclosure and an explanation of the technical principles used. Those skilled in the art should understand that the scope of the disclosure involved in this disclosure is not limited to the specific combination of the technical features of the above technical solutions, but should also cover other technical solutions formed by any combination of the above technical features or equivalent features without departing from the above disclosure concept. For example, the technical solutions formed by replacing the above features with (but not limited to) technical features with similar functions disclosed in this disclosure.

In addition, although the operations are depicted in a specific order, this should not be understood as requiring these operations to be performed in the specific order shown or in sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims.

1. A method for data transmission, wherein the method is applied at a cloud server, and the method comprises:
obtaining target media data to be sent to a terminal device;
determining at least two physical transmission paths from the cloud server to the terminal device; and
transmitting the target media data to the terminal device on the at least two physical transmission paths, wherein media data transmitted on each of the physical transmission paths is part or all of the target media data.

2. The method of claim 1, wherein transmitting the target media data the terminal device on the at least two physical transmission paths comprises:
determining respective media data to be transmitted corresponding to the at least two physical transmission paths according to the target media data;
encoding the media data to be transmitted corresponding to each of the physical transmission paths to obtain the encoded data corresponding to the physical transmission path; and
transmitting the respective encoded data on the at least two physical transmission paths to the terminal device.

3. The method of claim 2, wherein the target media data comprises a plurality of image frames, and wherein determining respective media data to be transmitted corresponding to the at least two physical transmission paths according to the target media data comprises:
determining respective image frames corresponding to the at least two physical transmission paths from the plurality of image frames.

4. The method of claim 3, wherein a number of the at least two physical transmission paths is K, and, for the i-th physical transmission path where i is an integer less than or equal to K, determining the image frame corresponding to the i-th physical transmission path comprises:
determining that the image frames corresponding to the first physical transmission path comprise the i-th, (i+K)-th, (i+2*K)-th . . . , and (i+n*K)-th image frames from the plurality of image frames, wherein n is the maximum value satisfying i+n*K≤L, and L is a number of the plurality of image frames.

5. The method of claim 4, wherein the encoded data corresponding to each of the physical transmission paths comprises a key frame and a non-key frame, and positions of the key frames in the encoded data corresponding to different physical transmission paths are different.

6. The method of claim 3, wherein determining respective image frames corresponding to the at least two physical transmission paths from the plurality of image frames comprises:
determining network quality corresponding to the at least two physical transmission paths; and
determining the respective image frames corresponding to the at least two physical transmission paths from the plurality of image frames based on the network quality corresponding to the at least two physical transmission paths.

7. The method of claim 6, wherein the at least two physical transmission paths comprise a first and a second physical transmission paths;
if the network quality corresponding to the first physical transmission path is better than the network quality corresponding to the second physical transmission path, a number of the image frames corresponding to the first physical transmission path is greater than a number of the image frames corresponding to the second physical transmission path.

8. The method of claim 3, wherein the at least two physical transmission paths comprise a first and a second physical transmission paths, and wherein determining respective image frames corresponding to the at least two physical transmission paths from the plurality of image frames comprises:
determining all image frames in the plurality of image frames as the image frames corresponding to the first physical transmission path; and
determining a part of the image frames in the plurality of image frames as the image frames corresponding to the second physical transmission path.

9. The method of claim 2, wherein determining respective media data to be transmitted corresponding to the at least two physical transmission paths according to the target media data comprises:
determining the target media data as the media data to be transmitted corresponding to each of the physical transmission paths.

10-14. (canceled)

15. An electronic device comprising:
a processor; and
a memory storing computer-executable instructions that, when executed by the processor, perform acts comprising:
obtaining target media data to be sent to a terminal device;
determining at least two physical transmission paths from a cloud server to the terminal device; and
transmitting the target media data to the terminal device on the at least two physical transmission paths, wherein media data transmitted on each of the physical transmission paths is part or all of the target media data.

16. The electronic device of claim 15, wherein transmitting the target media data the terminal device on the at least two physical transmission paths comprises:
determining respective media data to be transmitted corresponding to the at least two physical transmission paths according to the target media data;
encoding the media data to be transmitted corresponding to each of the physical transmission paths to obtain the encoded data corresponding to the physical transmission path; and
transmitting the respective encoded data on the at least two physical transmission paths to the terminal device.

17. The electronic device of claim 16, wherein the target media data comprises a plurality of image frames, and wherein determining respective media data to be transmitted corresponding to the at least two physical transmission paths according to the target media data comprises:
determining respective image frames corresponding to the at least two physical transmission paths from the plurality of image frames.

18. The electronic device of claim 17, wherein a number of the at least two physical transmission paths is K, and, for the i-th physical transmission path where i is an integer less than or equal to K, determining the image frame corresponding to the i-th physical transmission path comprises:
determining that the image frames corresponding to the first physical transmission path comprise the i-th, (i+K)-th, (i+2*K)-th . . . , and (i+n*K)-th image frames from the plurality of image frames, wherein n is the maximum value satisfying i+n*K≤L, and L is a number of the plurality of image frames.

19. The electronic device of claim 18, wherein the encoded data corresponding to each of the physical transmission paths comprises a key frame and a non-key frame, and positions of the key frames in the encoded data corresponding to different physical transmission paths are different.

20. The electronic device of claim 17, wherein determining respective image frames corresponding to the at least two physical transmission paths from the plurality of image frames comprises:
determining network quality corresponding to the at least two physical transmission paths; and
determining the respective image frames corresponding to the at least two physical transmission paths from the plurality of image frames based on the network quality corresponding to the at least two physical transmission paths.

21. The electronic device of claim 20, wherein the at least two physical transmission paths comprise a first and a second physical transmission paths;
if the network quality corresponding to the first physical transmission path is better than the network quality corresponding to the second physical transmission path, a number of the image frames corresponding to the first physical transmission path is greater than a number of the image frames corresponding to the second physical transmission path.

22. The electronic device of claim 17, wherein the at least two physical transmission paths comprise a first and a second physical transmission paths, and wherein determining respective image frames corresponding to the at least two physical transmission paths from the plurality of image frames comprises:
determining all image frames in the plurality of image frames as the image frames corresponding to the first physical transmission path; and
determining a part of the image frames in the plurality of image frames as the image frames corresponding to the second physical transmission path.

23. The electronic device of claim 16, wherein determining respective media data to be transmitted corresponding to the at least two physical transmission paths according to the target media data comprises:
determining the target media data as the media data to be transmitted corresponding to each of the physical transmission paths.

24. A non-transitory computer-readable storage medium storing computer-executable instructions, the computer-executable instructions, when executed by a processor, implementing:
obtaining target media data to be sent to a terminal device;
determining at least two physical transmission paths from the cloud server to the terminal device; and
transmitting the target media data to the terminal device on the at least two physical transmission paths, wherein media data transmitted on each of the physical transmission paths is part or all of the target media data.
